(19) United States
(12) Patent Application Publication
(10) Pub. No.: US 2009/0193446 A1
(43) Pub. Date: Jul. 30, 2009

(54) Apparatuses for Transportation of Disc in Connection with Recording Data and Apparatus for Such Recording

(75) Inventors: Gary Temush, Carlisle (CA); Michael Atkinson, Oakville (CA); Av Utukuri, Mississauga (CA); Nick Molo, Mississauga (CA); Anthony Gussin, Toronto (CA); Ted Chen, North York (CA); Jonathan Clarke, North York (CA)

Correspondence Address: BARNES & THORNBURG LLP, 750-17TH STREET NW, SUITE 900, WASHINGTON, DC, 20006-4675, US

(73) Assignee: Raptor Innovations International, Inc., Mississauga (CA)

(21) Appl. No.: 12/021,787

(22) Filed: Jan. 29, 2008

(51) Int. Cl. G11B 17/03

(52) U.S. Cl. 720/601

(57) ABSTRACT

An apparatus for the transport of discs for duplication of data onto the discs. The apparatus may include a transportation mechanism, control device, power module and optionally a disc recording mechanism and housing. The transportation mechanism may include an arm, and one or more gear assemblies. Further, the apparatus may also include a drawer device and a plurality of disc holders.

The invention relates an apparatus for transportation of a disc in connection with recording data and apparatus for such recording, as specified in the independent claims. More particularly, the invention is directed toward an apparatus enabling automated or semi-automated reproduction of discs.

### BACKGROUND OF THE INVENTION

As is conventionally known Compact Discs (CDs), whether they be recordable or rewritable, are frequently used to record audio and video data. Such discs are also used to record data, including computer software and data of various types. Such discs, like Digital Video Discs (DVDs) and Blu-ray Discs and are characterized by a construction which is formed of a plurality of layers, including a reflective inner layer and a protective top layer upon which characters and graphics can be printed using an appropriate printing mechanism. Such discs are described throughout this application as discs.

Conventionally, various devices are provided for recording discs in an automated manner to provide for disc duplication projects in manufacturing and other industrial and business settings. However, such devices are expensive, large in size and are generally designed for mass production of discs. U.S. Pat. No. 5,946,216 to Hollerich provides such an apparatus configured to pick up and place discs in such equipment.

However, as such discs are used more often in industry, business and in our personal lives, it has been recognized that there is a need for smaller, more economical devices for recording a number of discs in an automated manner. Thus, U.S. Pat. Pub. 20070147191 for Liu et al. provides a recording system that uses a mechanical arm under a computer controlling system to retrieve an unrecorded disc from an unrecorded disc stack and release the unrecorded disc into the disc tray of the optical disc drive. Liu further recognizes that, by the computer controlling system and mechanical arm, the procedures of disc copying can be done automatically, thus faster and more efficiently than in the past.

### SUMMARY OF THE INVENTION

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

In accordance with at least one embodiment of the invention, an apparatus is provided that is configured to perform disc transportation, for example, disc retrieval and release using an arm for retrieving discs from a disc store and releasing the discs into a disc tray of a disc recordation device, as specified in the independent claims. Accordingly, dependent claims prescribe further detailed implementations of the present invention.

Thus, in operation, the apparatus is configured such that the arm moves in a single plane by performing retrieval of a disc and release of the disc in two dimensions only.

### BRIEF DESCRIPTION OF THE DRAWINGS

A more complete understanding of the present invention and the utility thereof may be acquired by referring to the following description in consideration of the accompanying drawings, in which like reference numbers indicate like features, and wherein:

FIG. 1 illustrates a perspective view of an apparatus provided in accordance with at least one embodiment of the invention.

FIG. 2 illustrates a side elevational view of an apparatus provided in accordance with at least the embodiment of the invention illustrated in FIG. 1.

FIG. 3 illustrates a front elevational view of an apparatus provided in accordance with at least the embodiment of the invention illustrated in FIG. 1.

FIG. 4 illustrates a side elevational view of an apparatus provided in accordance with at least the embodiment of the invention illustrated in FIG. 1.

FIG. 5 illustrates a rear elevational view of an apparatus provided in accordance with at least the embodiment of the invention illustrated in FIG. 1.

FIG. 6 illustrates a top plan view of an apparatus provided in accordance with at least the embodiment of the invention illustrated in FIG. 1.

FIG. 7 illustrates an enlarged side elevational view of a gripper arm head assembly for an apparatus provided in accordance with at least the embodiments of the invention illustrated in FIGS. 1, 8 and 14.

FIG. 8 illustrates a perspective view of an apparatus provided in accordance with at least one embodiment of the invention.

FIG. 9 illustrates a side elevational view of an apparatus provided in accordance with at least the embodiment of the invention illustrated in FIG. 8.

FIG. 10 illustrates a front elevational view of an apparatus provided in accordance with at least the embodiment of the invention illustrated in FIG. 8.

FIG. 11 illustrates a side elevational view of an apparatus provided in accordance with at least the embodiment of the invention illustrated in FIG. 8.

FIG. 12 illustrates a rear elevational view of an apparatus provided in accordance with at least the embodiment of the invention illustrated in FIG. 8.

FIG. 13 illustrates a top plan view of an apparatus provided in accordance with at least the embodiment of the invention illustrated in FIG. 8.

FIG. 14 illustrates a perspective view of the apparatus illustrated in FIG. 8 in an alternative position.

FIG. 15 illustrates a side elevational view of an apparatus provided in accordance with at least the embodiment of the invention illustrated in FIG. 14.

FIG. 16 illustrates a front elevational view of an apparatus provided in accordance with at least the embodiment of the invention illustrated in FIG. 14.

FIG. 17 illustrates a side elevational view of an apparatus provided in accordance with at least the embodiment of the invention illustrated in FIG. 14.

FIG. 18 illustrates a rear elevational view of an apparatus provided in accordance with at least the embodiment of the invention illustrated in FIG. 14.

FIG. 19 illustrates a top plan view of an apparatus provided in accordance with at least the embodiment of the invention illustrated in FIG. 14.

FIG. 20 illustrates a perspective view of an apparatus provided in accordance with at least one embodiment of the invention.

FIG. 21 illustrates a side elevational view of an apparatus provided in accordance with at least the embodiment of the invention illustrated in FIG. 20.

FIG. 22 illustrates a front elevational view of an apparatus provided in accordance with at least the embodiment of the invention illustrated in FIG. 20.

FIG. 23 illustrates a side elevational view of an apparatus provided in accordance with at least the embodiment of the invention illustrated in FIG. 20.

FIG. 24 illustrates a rear elevational view of an apparatus provided in accordance with at least the embodiment of the invention illustrated in FIG. 20.

FIG. 25 illustrates a top plan view of an apparatus provided in accordance with at least the embodiment of the invention illustrated in FIG. 20.

FIG. 26 illustrates an expanded view of the dual arm linkage assembly provided in accordance with at least the embodiment of the invention.

FIG. 27 illustrates a perspective view of the blank disc cassette provided in accordance with at least the embodiment of the invention.

### DETAILED DESCRIPTION OF EMBODIMENTS

In the following description of various invention embodiments, reference is made to the accompanying drawings, which form a part hereof, and in which is shown, by way of illustration, various embodiments in which the invention may be practiced. It should be understood that other embodiments may be utilized and structural and functional modifications may be made without departing from the scope and spirit of the present invention.

Moreover, it should be understood that various connections are set forth between elements in the following description; however, these connections in general, and, unless otherwise specified, may be either direct or indirect, either permanent or transitory, and either dedicated or shared, and that this specification is not intended to be limiting in this respect.

In accordance with at least one embodiment of the invention, an apparatus is provided that is configured to perform disc transportation, for example, disc retrieval and release using a gripper arm for retrieving discs from a disc store and releasing the discs into a disc tray of a disc recordation device. In operation, the apparatus may be configured such that the gripper arm moves in a single plane by performing retrieval of a disc and release of the disc in two dimensions only. This disc transportation equipment and resulting functionality may be combined with equipment for performing disc recordation to provide a compact disc burner capable of performing recordation of a plurality of discs in an automated or semi-automated manner.

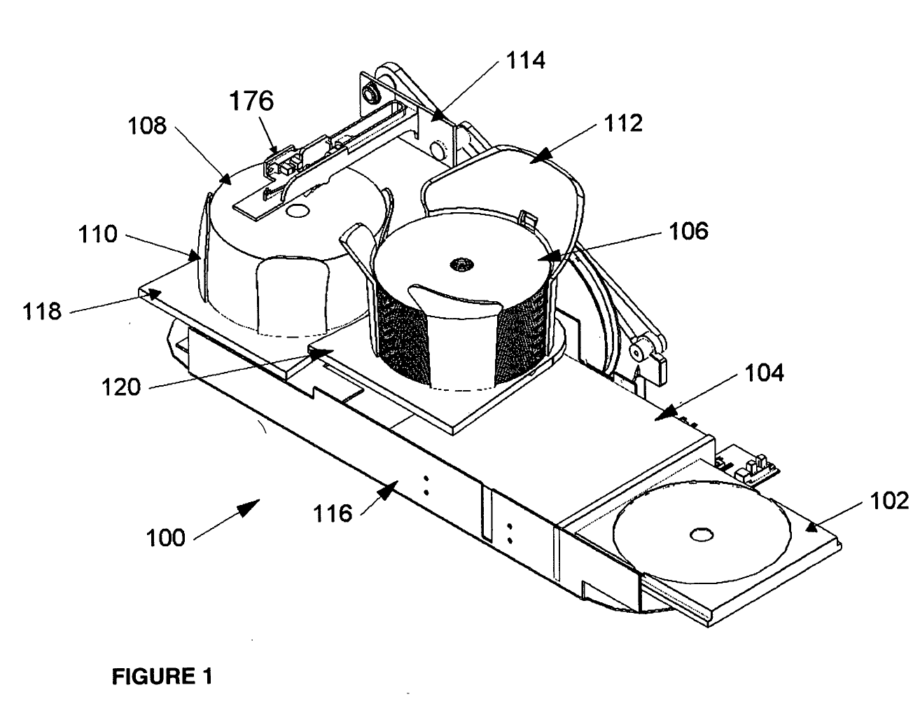

As illustrated in FIG. 1, one example of a disc a disc transportation apparatus may be combined with a disc recorder (e.g., duplicator or burner).

As is conventionally understood, discs to be recorded (e.g., blank discs) are generally plastic with a hole located in the middle of the disc. Such discs are generally circular; however, they may have various shapes including, for example, rectilinear or with parallel sides and rounded or curved ends. The apparatus may include a housing 116, which may include, as illustrated in FIG. 1, a conventionally known disc recorder 104. For example, although not expressly illustrated, it should be understood that the housing may include components provided and operable to enable a write laser to move in a prescribed configuration while the disc to be recorded spins. As is conventionally understood, a blank disc such as a recordable disc has a smooth reflective metal layer, which rests on top of a layer of photosensitive dye. When the disc is blank, the dye is translucent. However, to write data to the disc, the dye layer is heated using a laser. Thus, when the dye layer is heated with a concentrated light, e.g., a laser, of a particular frequency and intensity, the dye turns opaque.

By selectively darkening particular points along the disc track, and leaving other areas of dye translucent, a digital pattern is created that a standard disc player can read. The light from the player's laser beam only bounces back to the sensor when the dye is left translucent, in the same way that it will only bounce back from the flat areas of a conventional disc.

Thus, conventional disc recorders record, or “burn” digital patterns onto blank discs. Therefore, a conventional disc recorder has a moving laser assembly. But in addition to the standard “read laser,” it has a “write laser.” The write laser is more powerful than the read laser, so it interacts with the disc differently: It alters the surface instead of just bouncing light off it. The write laser moves in exactly the same way as the read laser by moving outward while the disc spins. The bottom plastic layer has grooves pre-pressed into it, to guide the laser along the correct path. By calibrating the rate of spin with the movement of the laser assembly, the recorder keeps the laser running along the track at a constant rate of speed. To record the data, the recorder simply turns the laser writer on and off in synch with the pattern of 1s and 0s. The laser darkens the material to encode a 0 and leaves it translucent to encode a 1. Depending on whether a disc is recordable or rewritable, data recorded in a disc can be re-recorded.

As illustrated in the FIGURES, e.g., FIG. 1, the disc recorder 104 may be any one of a number of conventionally available disc recording apparatuses. All that is necessary for implementation of the apparatus 100 is a coordinated interaction between the disc recorder 104 and other components of the apparatus 100 provided in association with and functioning to transport both blank discs 108 and recorded discs 106 from/to respective storage stations/areas 118, 120.

To provide storage of a number of discs to be recorded 108, a first disc store cassette 110 is provided in the blank disc storage station/area 118. The cassette 110 may include one or more vertical supports that attach either to the bottom of the cassette or to the base plate. The curving nature of the disc store cassette 110 enables the gripper arm assembly 176 to more effectively interface with the discs stored in the cassette 10 based on the curvature of the path of the gripper arm 158. That is, as the number of discs stored in the cassette reduces, the placement of the gripper arm 158 will alter because the gripper arm 158 is moved via the dual arm linkage assembly 114. However, it should be appreciated that, in at least one implementation of the invention, the curved nature of the cassette 110 is not necessary.

To provide storage of a number of recorded discs 106, a second disc store cassette 112 may be provided in the recorded disc storage station/area 120. It should be understood that the cassette 112 may be shaped as illustrated in FIGS. 1-6 to provide a tapered diameter to facilitate collection of recorded discs 106 once those discs are released from the gripper arm assembly 176.

The disc recorder 104 may include a tray 102 that extends from the housing of the recorder 104 under a control program 9, which may be implemented as machine executable instructions for a control module and/or power module for the recorder 104 (not shown but included in the housing of recorder 104).

The disc support tray 102 may be configured to hold a disc following transport of the disc to the tray 102 via the gripper arm 158 and during recordation of data by the recorder 104. When a disc is in the tray 102, the tray 102 can be moved so that the tray 102 is moved inwardly and outwardly from housing of the recorder 104 to implement loading and unloading of the disc into the housing of the recorder 104. Thus, the tray 102 may extend to a position where a blank disc 108 can be placed onto the respective tray 102. Subsequently, under the direction of the control program, the tray 102 may recede back into the housing 104 for recordation of data on the disc (e.g., using conventionally understood disc writing technology). Following completion of operations performed for recording data on the recorded disc 106, the tray 102 may be controlled by the control program to extend to a position where the recorded disc 106 can be retrieved from the tray 102 and deposited in the disc store 112 by the gripper arm 158.

Thus, after information is recorded on the recorded disc 106 located in tray 102, the tray 102 may be moved back to the extended position where the disc is accessible for the disc gripper arm 158 to be moved in conjunction with operation of the disc gripper arm head assembly 176 to engage the disc hole and pick up the disc for transportation to a post recordation disc store station/area 120. This results in the tray 102 being cleared for insertion of another blank disc 108 to be recorded, once the recorded disc 106 has been released in the post record disc store station 120 by the disc gripper arm head assembly 176.

Thus, operations of various components of the apparatus 100 can be controlled so as to provide a sequence of cooperative actions to facilitate transportation of a disc to be recorded to/from the tray 102 of the disc recorder 104. For example, the disc to be recorded can be picked from the disc storage cassette 110 and moved to a position overlying the tray 102 for the disc recorder 104 when the tray 102 is extended, and then dropped in place by the gripper arm head assembly 176 releasing the disc (as explained in more detail with reference to the other figures). Subsequently, programmed control instructions provided in a control module of the apparatus 100 (not expressly illustrated but included in housing 116) may cause the disc tray 102 to move into the housing of disc recorder 104.

As illustrated in FIG. 1, discs to be recorded 108 (e.g., blank discs) may be stored in a first stack or storage area 118 that may be implemented in whole or in part by a disc cassette 110.

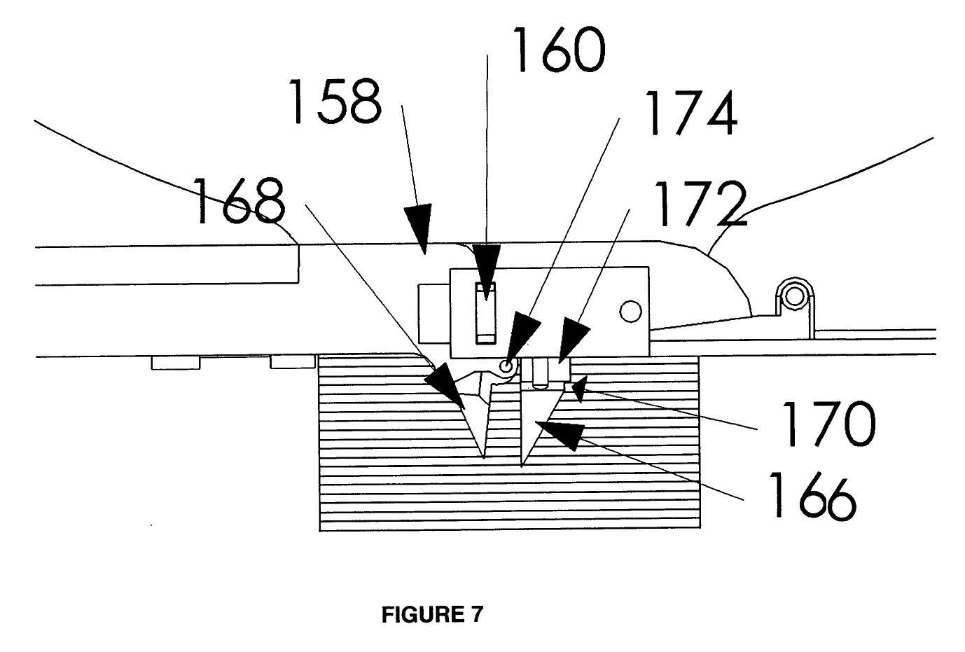

Individual discs may be lifted with the disc gripper arm head assembly 176 (illustrated in additional detail in FIG. 7) mounted on disc gripper arm 158. Thus, the gripper arm 158 may be configured such that a disc is moved in a single plane (i.e., along two axis of movement) between the pre-recorded disc storage station 118, the disc recorder 104 and the post-record store station 120. This single plane movement reduces the complexity and cost of the apparatus 100, as well as providing rapid easily controlled operations.

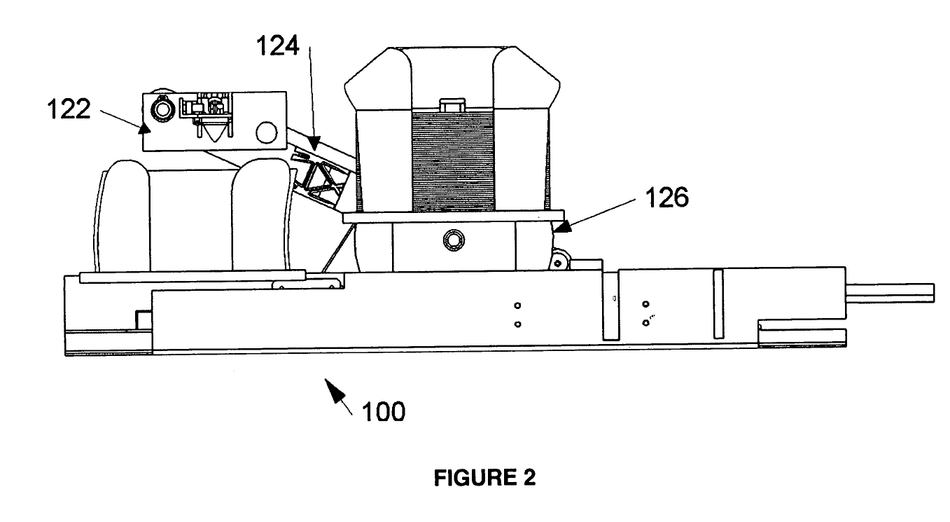

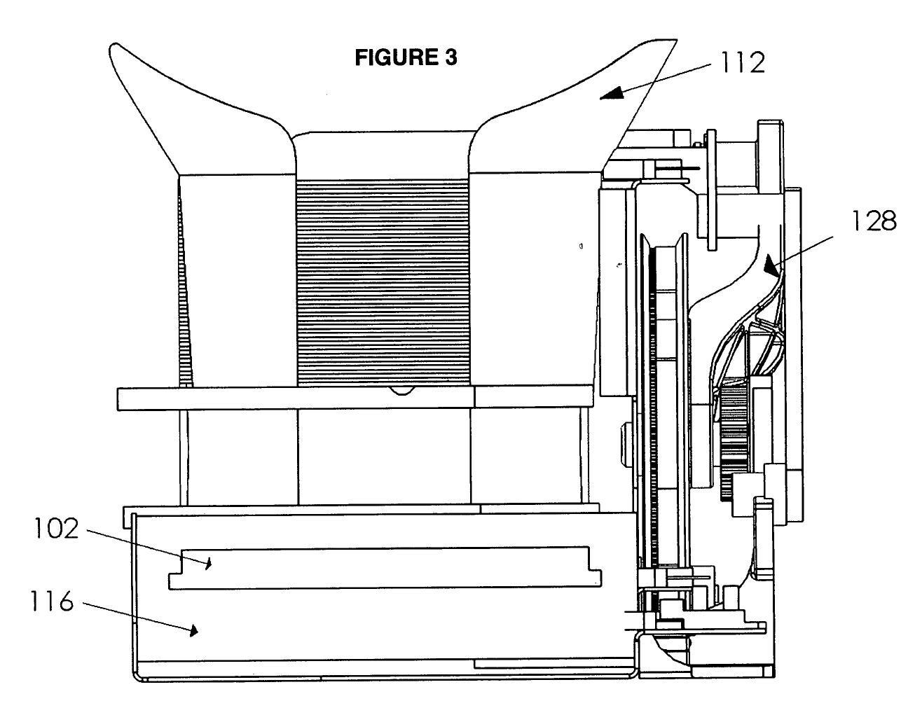

To provide this single plane movement, the gripper arm 158 may be attached to a dual arm linkage assembly 114, which in turn is connected to a gear assembly via interaction with a pulley arm 124 and a slave drive arm 150 at a juncture plate 122 (see FIG. 2). Thus, it should be appreciated that the dual arm linkage assembly 114 includes the pulley arm 124, slave drive arm 150 and juncture plate 122. The dual arm linkage assembly 114 couples the gripper arm 158 to the gear assembly (described in greater detail with reference to FIGS. 3-6) to provide the single plane movement of the gripper arm 158.

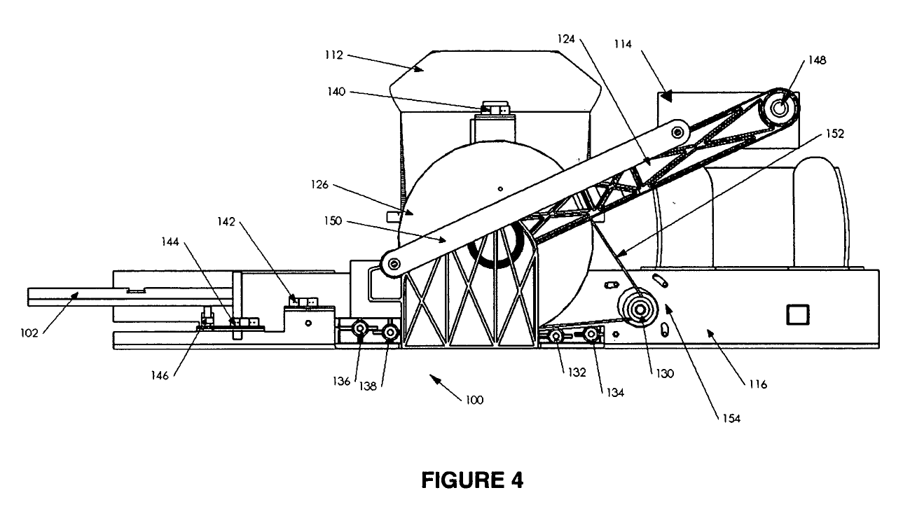

As illustrated in FIG. 4, the gear assembly included in the apparatus 100 may include various pulleys, belts and arms so as to translate movement force provided by a motor 154 included in the housing 116 of the apparatus 100 into the single plane movement of the gripper arm 158. More specifically, as illustrated in FIG. 4, the gear assembly includes a timing belt 152 coupled to a motor 154 (providing rotational movement at the axis of rotation 130 and also to a major pulley 126 (also illustrated in FIG. 2). The major pulley 126 is also coupled to the pulley arm 125 included in the dual arm linkage assembly 114, which is coupled to minor pulley 148. Minor pulley 148 enables the gripper arm 158 to maintain a consistent relationship with the normal plane for the apparatus 100 (to ensure that the griper arm 158 maintains a parallel relationship with the orientation of the discs 108 and the tray 102). Also included in the gear assembly are a number of additional pulleys 132, 134, 136 and 138 that aid in operation of the timing belt 152, e.g., to ensure that the timing belt remains in operational relationship with the major pulley 126.

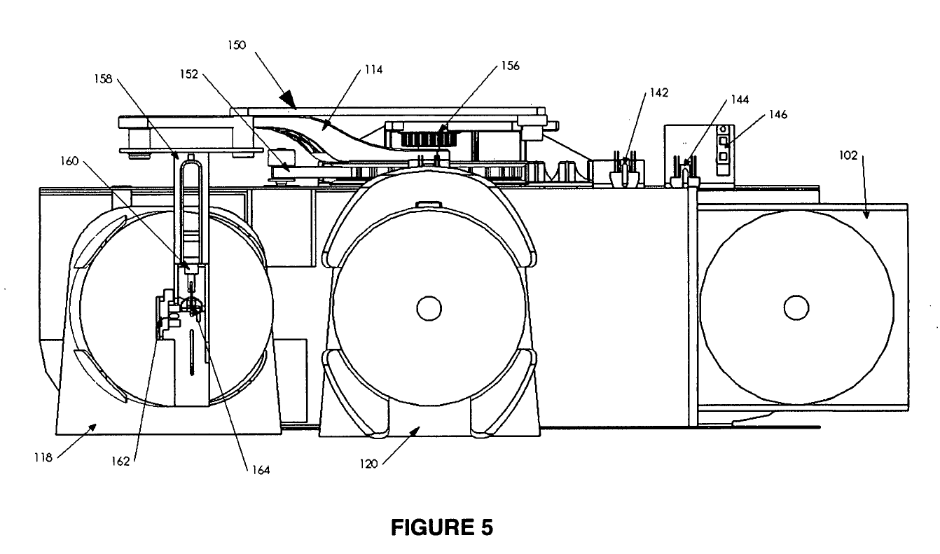

As illustrated in FIG. 5, the dual arm linkage assembly 114 may be configured to provide a bend in the pulley arm 125 so as to compensate for location of the major pulley 126 as the dual arm linkage assembly 114 is moved from the blank disc storage station 118 to the recorder tray 102. As a result, it should be appreciated that the dual arm linkage assembly 114 provides movement among the blank disc storage station 118, the recorded disc storage station 120 and the recorder tray 102 by movement force provided by the major pulley 126 via coupling 156 of that pulley to the dual arm linkage assembly 114.

As illustrated in FIGS. 7-9, the gripper arm head assembly 176 is mounted on the gripper arm 158 and enables interaction with the central openings of discs to facilitate transportation of a disc to and from the recorder tray 102.

Further to the explanation of apparatus operation provided above, it should be understood that, in operation of the apparatus 100, the gripper arm 158 may be moved downwardly so the gripper arm head assembly 176 engages a blank disc 108 from the disc storage cassette 110 located in storage station/area 118 (illustrated in FIG. 1). The solenoid 160 may be activated so a blank disc 108 is gripped. The arm 158 may then be moved in a single plane of operation by operation of the gear assembly (described in association with FIGS. 3-6) to enable placement of the blank disc 108 in the recorder tray 102.

Once the blank disc 108 is deposited in the tray 102 and released by the gripper arm head assembly 176, the tray 102 may be retracted into the housing of the recorder 104 for the recording operation. That retraction and recording operation may be performed under control of the recorder 104 (more specifically, a controller included in the recorder 104; not shown). Thus, a recording sequence may be selected by machine instructions of the recorder 104, which may be as provided by or specified in a recorder manufacturer.

Once recording of the disc is complete, the tray 102 will be extended back out to the loading/unloading position. The recorded disc 106 may then be picked up with the gripper arm 158 using the gripper arm head assembly 176 in the same manner performed when picking up the disc prior to recordation. Subsequently, the gripper arm 158 may be moved to a position where the recorded disc 106 may be released into a post-record disc store station/area 120 (e.g., in cassette 112) in the same manner as when the disc to be recorded 106 was released into the tray 102 of the recorder 104.

Returning to description of components illustrated in FIG. 4, it should be understood that a number of photo transistors and photointeruptors may be used at various locations in the apparatus 100 to ensure that discs are correctly picked up and deposited in various locations during initial storage, pre-recordation transportation, recordation, transportation subsequent to recordation and storage. For example, phototransistors 140, 142 and 144 may be provided to detect various locations of discs and components of the apparatus to control operation of the apparatus. For example, phototransistor 140 may be provided in proximity to the disc storage stations/areas to indicate whether a disc has been engaged by the gripper arm head assembly 176, deposited in a storage station/area, dropped, etc. Likewise, phototransistor 142 may be provided to generate information regarding the relative location of the dual arm linkage assembly 114. Further, phototransistor 144 may be provided to indicate when a disc has been dropped improperly from the gripper arm 158. Further, photointeruptor 146 may be located in proximity to indicate to the tray 102 to indicate when the tray is open, closed, or has malfunctioned.

Likewise, photointeruptor assembly 162 illustrated in FIG. 5 is provided to enable precise movement of the gripper arm 158 in relationship to the discs to enable picking up of individual discs. As a result, the photointeruptor assembly 162 may include a movable structural component that interacts with a disc prior to engaging of the disc such that movement of the structural component is registered by an photointeruptor in the assembly 162 to stop, slow or otherwise alter movement of the gripper arm 158 and/or gripper arm head assembly 176.

As is conventionally understood, discs have standard or standardized center openings; in order to handle the discs, the apparatus 100 includes a gripper arm 158 coupled via a dual arm linkage assembly 114 to the apparatus gear assembly and motor 154 under control of a control module included in but not shown in housing 116. The control module may be configured to include components enabling control of various operations of the apparatus 100 and interacts with, is controlled by or cooperates/communicates with a recorder control module (included in the housing of the recorder 104 but not shown) configured to control the transportation and recording of discs.

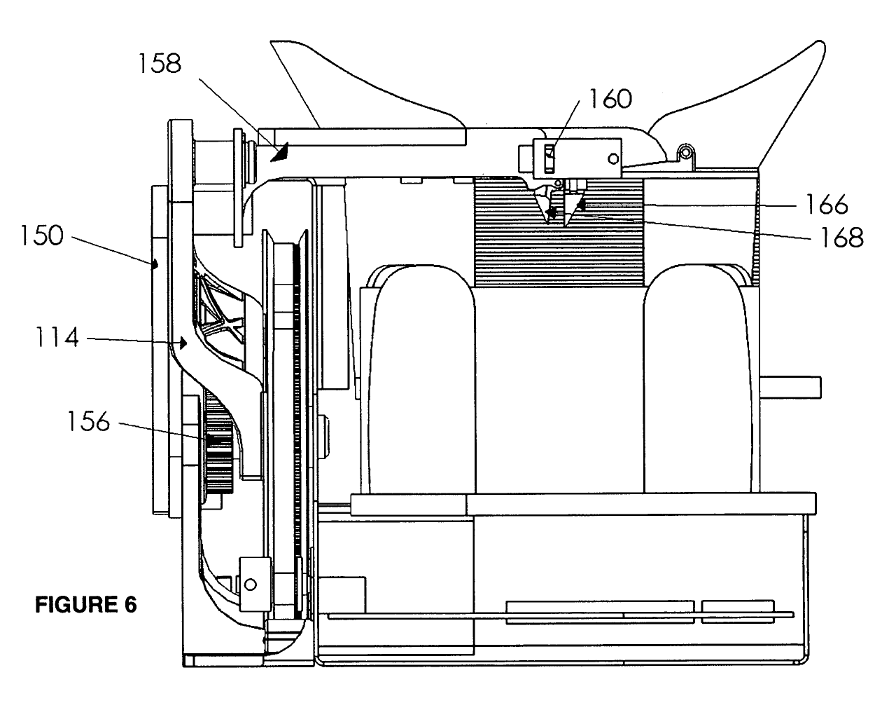

As illustrated in FIGS. 6 and 7, the disc gripper arm head assembly 176 can be of any desired form, but as shown in this example, the assembly 176 may have a plurality of fingers 166, 168 that may or may not have tapered ends. As illustrated in FIGS. 6 and 7, the fingers 166, 168 may be pressed together (via operation of a solenoid 160 and solenoid pull rod 164) providing movement of the fingers in relationship to pivot point 174) prior to interact with a central hole within a disc. Subsequent to the tapered ends passing through the hole of the disc, the plurality of fingers 166, 168 may be separated by operation of the solenoid 160 and solenoid pull rod 164 (illustrated in FIG. 5) mounted on the gripper arm 158 under the direction of the apparatus 100 control module. Thus, the solenoid 160 may be actuated to spread the tapered ends of the plurality of fingers 166, 168 to engage the inner surfaces of the opening in the center of a disc to be handled.

In additional detail, the disc gripper arm head assembly 176 may include not only the gripper fingers 166, 168 but also a photointeruptor 160 provided to ?. It should also be appreciated that the gripper arm head assembly 176 may be designed so as to aid in the engagement of a single disc by, for example, including a cylindrical portion 170 that has a height equal to the height of a single disc; this portion 170 may be coupled to a stopper portion 172 having a width dimension such that, when a disc is engaged by the separated plurality of fingers 166, 168, the disc is held in place parallel to the disc arm 158 so as to enable effective acquisition and transportation of the disc from/to stations 118, 120 and the disc recorder 104.

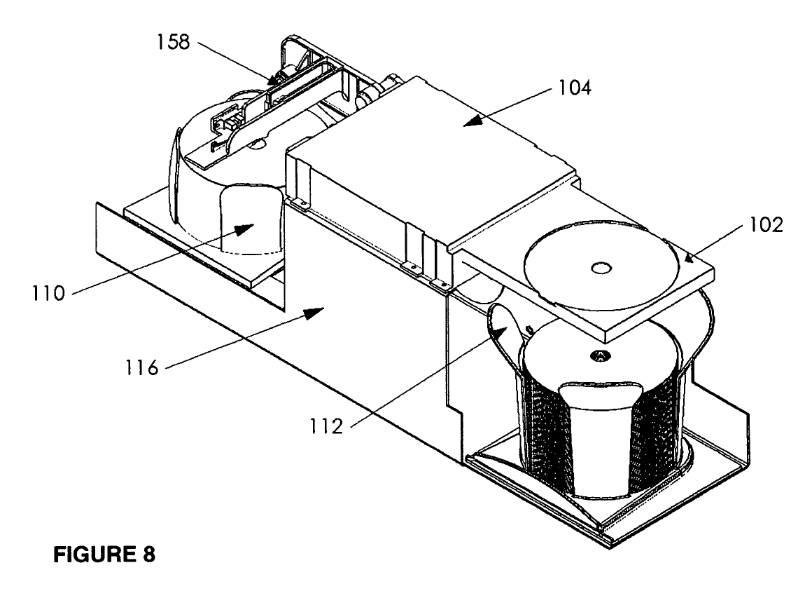

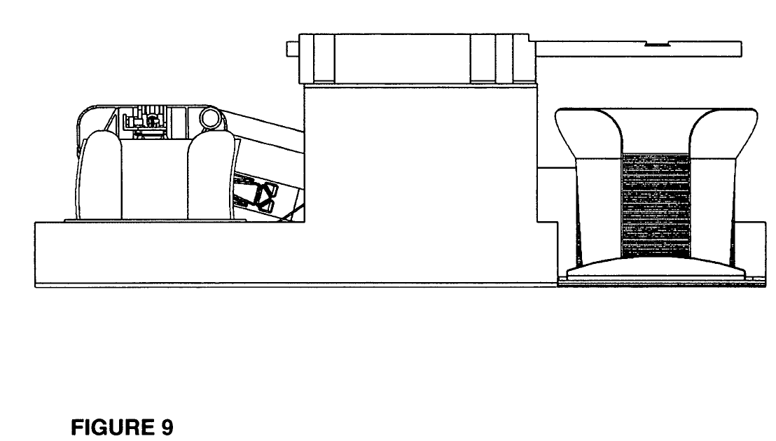

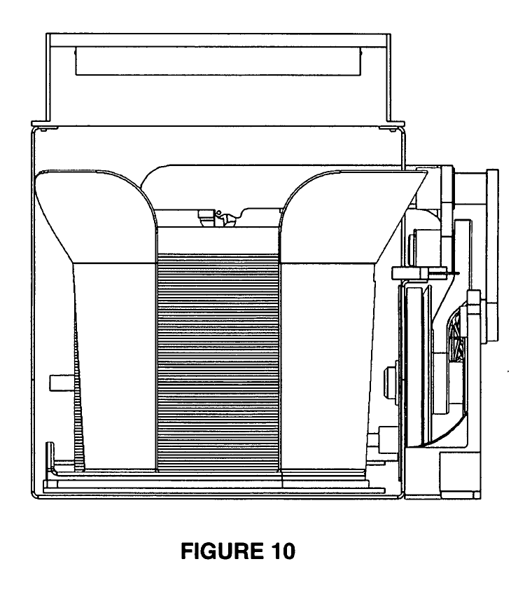

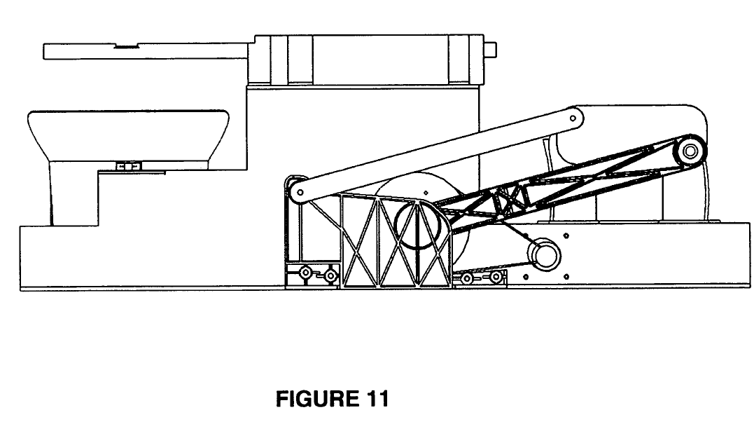

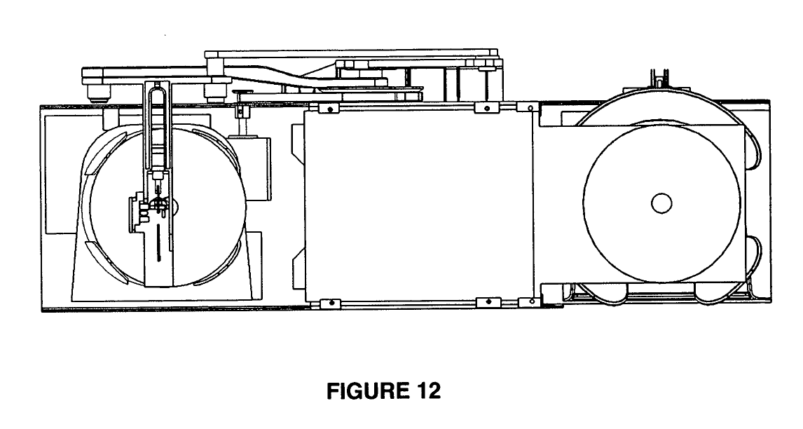

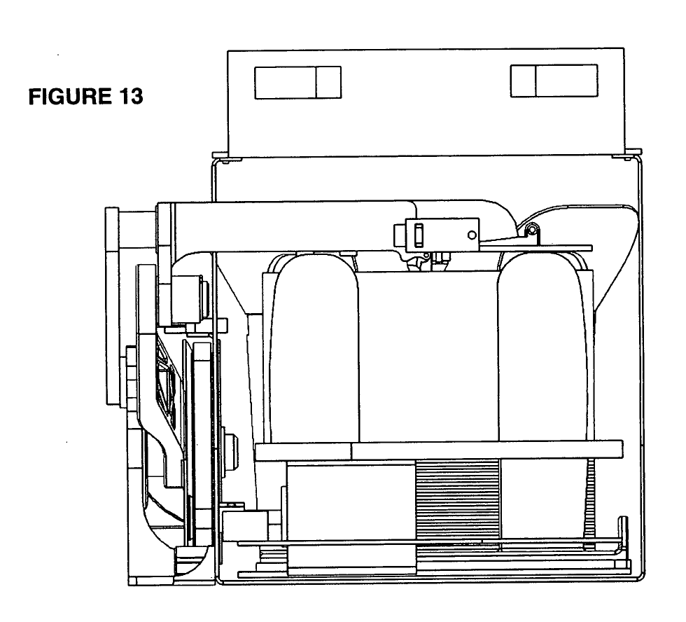

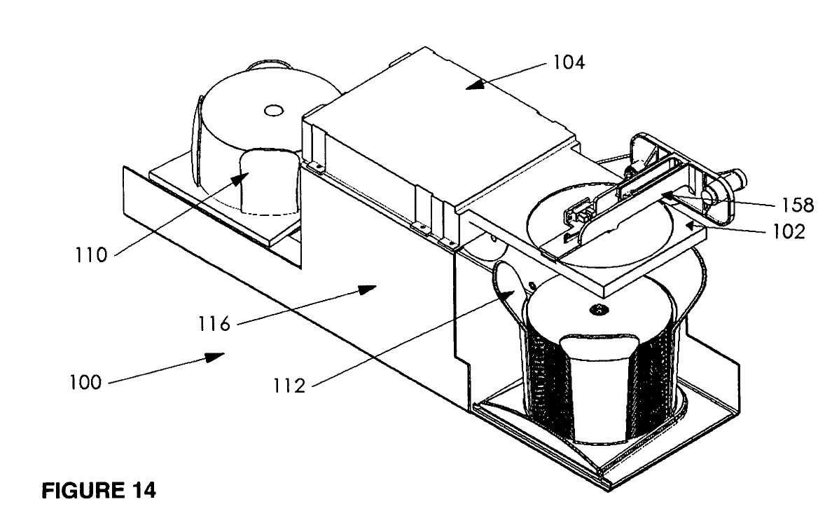

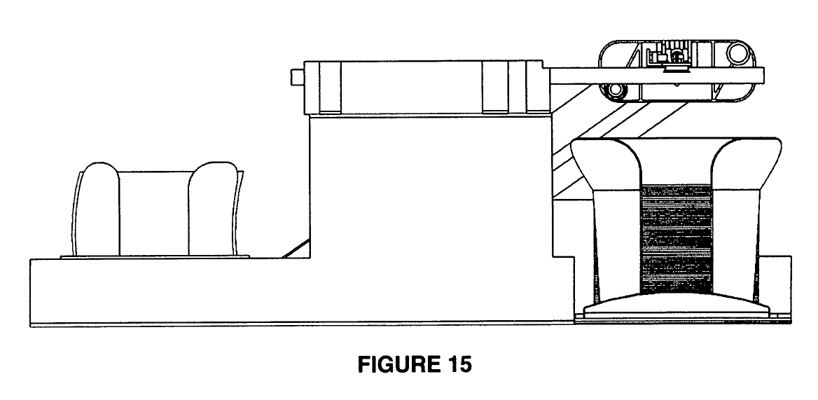

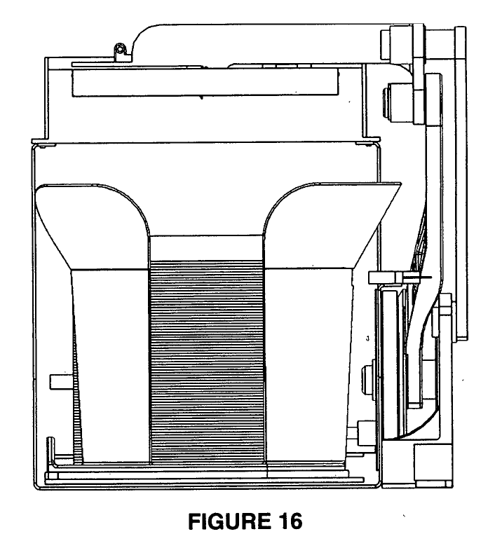

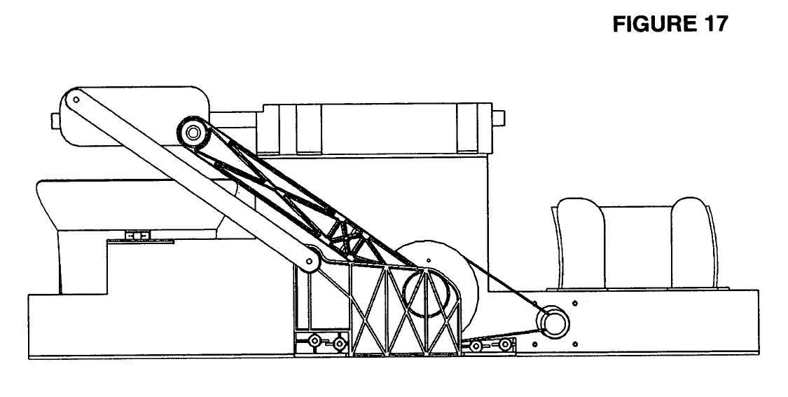

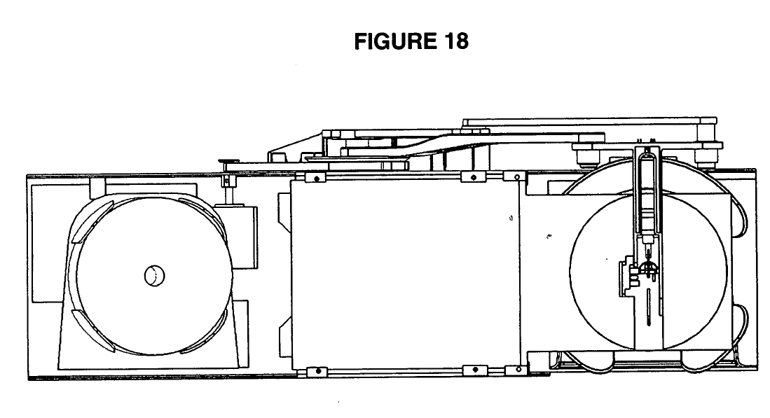

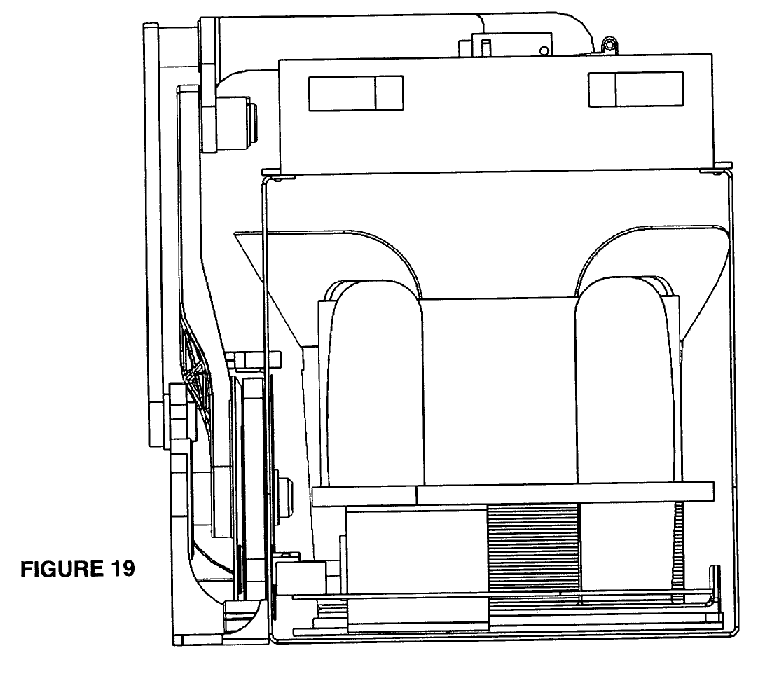

FIGS. 8-19 illustrate an alternative embodiment of the apparatus 100 which includes all the components of the embodiment illustrated in FIGS. 1-7 but in an alternative configuration. As can be understood with reference to FIG. 8, the position of the disc recorder 104 may be located between the blank disc station (including the cassette 110) and the recorded disc station (including cassette 112). This alternative configuration also takes advantage of the single plane movement operation of the gripper arm 158 and its cooperation with the motor (not shown) and gear assembly as illustrated in FIGS. 9-13. It should be appreciated that the gripper arm head assembly 176 included in this embodiment may be identical or substantially similar to that illustrated in FIGS. 5-7. FIGS. 14-19 illustrate the configuration illustrated in FIG. 8 but with the disc gripper arm 158 in a different operational position (i.e., over the recorder tray 102 as part of loading/unloading a disc from the tray 102).

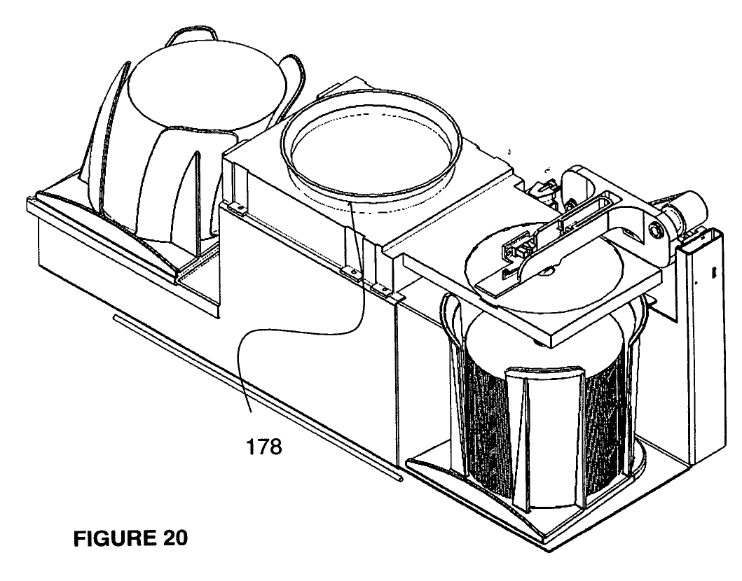

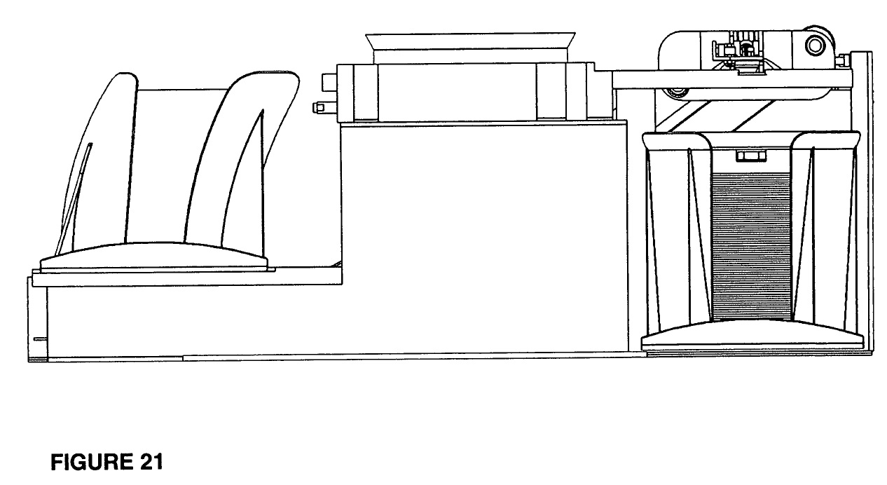

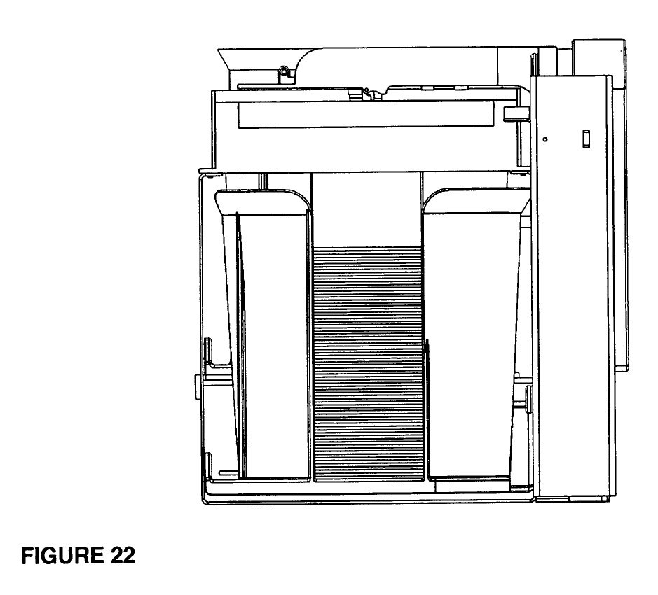

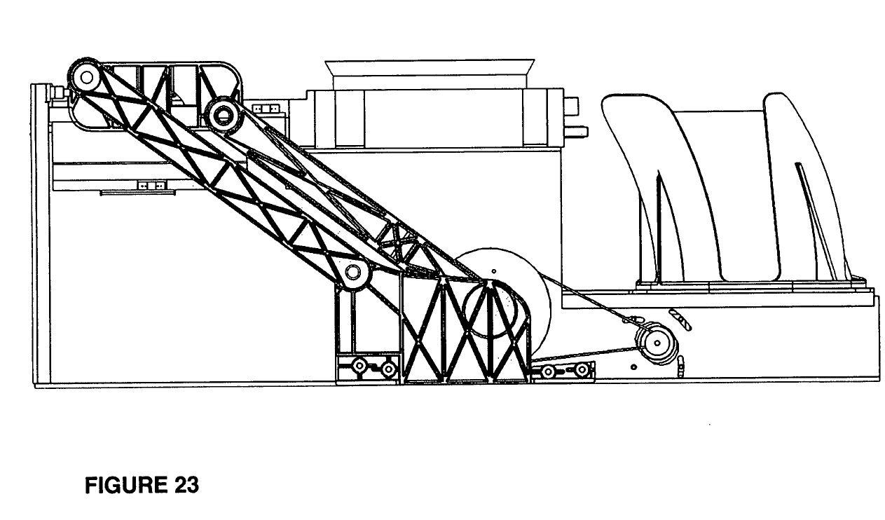

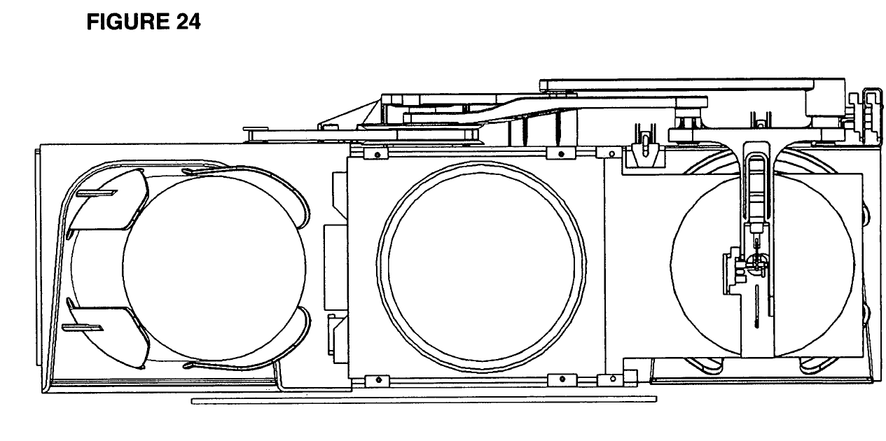

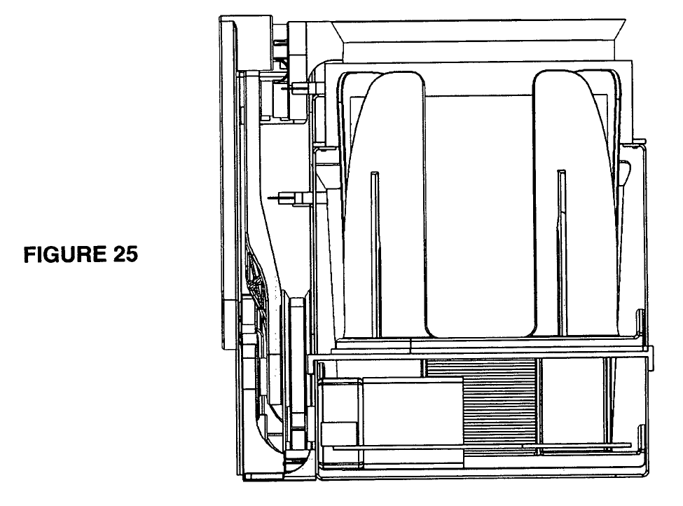

FIGS. 20-25 illustrate another alternative embodiment of the apparatus 100 which includes all the components of the embodiment illustrated in FIGS. 1-7 and those of 8-19 but in an alternative configuration. As can be understood with reference to FIG. 20, the position of the disc recorder 104 may be located between the blank disc station (including the cassette 110) and the recorded disc station (including cassette 112). Moreover, a repository 178 for “bad” discs, e.g., those that could not be recorded, may be located on top of the disc recorder 104. Therefore changes to the order of operation will need to be made in the application.

This alternative configuration also takes advantage of the single plane movement operation of the gripper arm 158 and its cooperation with the motor (not shown) and gear assembly as illustrated in FIGS. 9-13. It should be appreciated that the gripper arm head assembly 176 included in this embodiment may be identical or substantially similar to that illustrated in FIGS. 5-7.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

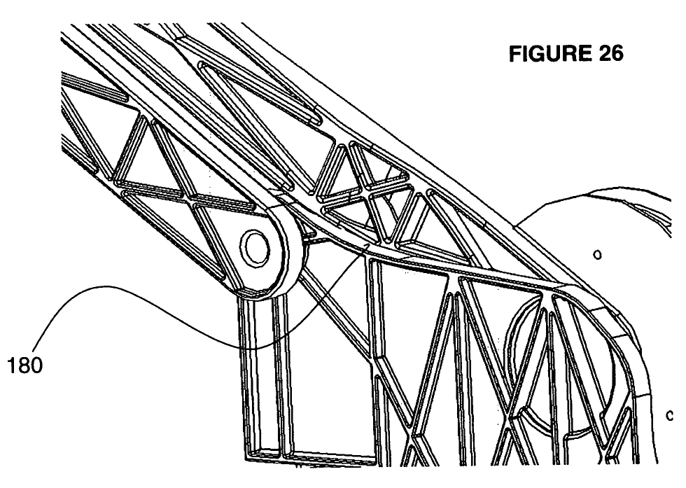

In accordance with at least one embodiment of the invention, and potentially all of the illustrated embodiments, the dual arm linkage assembly may include a built in stop 180 (see FIG. 26) on the arms to prevent the linkages from becoming collinear. This stop 180 has utility because, if the linkages were to become collinear there is a possibility that the disc gripper arm head assembly 176 may be in a point of inflection; as a result, the disc gripper arm head assembly 176 may no longer be horizontally level. One possible consequence of this is that the disc gripper arm head assembly 176 may become unable to pick up discs in a level manner. Accordingly, by including the stop 180, the arms of the dual arm linkage assembly are physically prevented from becoming collinear.

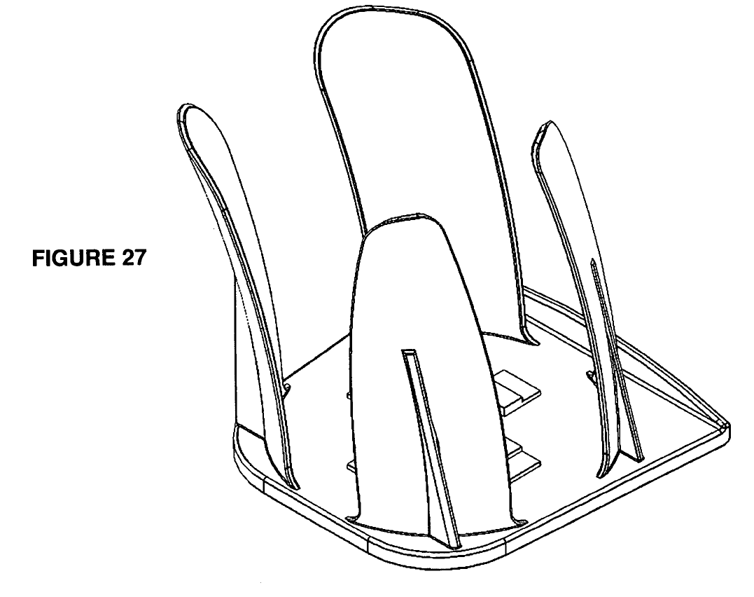

Additionally, in accordance with at least one embodiment of the invention, foam may be provided on the blank disc store cassette 110 as illustrated in FIG. 27 to enable the stack to “float,” i.e., move in a variable way in response to various forces applied upon it in various directions, for example, as the tack cassette responds to forces from the gripper arm movement. This aids in the pick-up of the CD by allowing the stack to self level/adjust with respect to the gripper arm pick-up head assembly.

It should be appreciated that the size and shape of the disc may vary in accordance with embodiments of the invention. Therefore, the disc storage cassettes 110 and 112 need not be of a particular size or shape. Moreover, alternative removable disc store cassettes may be provided for an apparatus designed in accordance with the invention such that the apparatus may be used to process different types or sizes of discs.

Further, it should be appreciated that the dimensions of the gripper arm 140 may be designed in accordance with the dimensions of the disc hole (e.g., radius, diameter) and thickness of a disc to be processed. Thus, it should be appreciated that, in accordance with at least one embodiment of the invention, all or part of the gripper arm 140 may be removable and replaceable with components of different dimensions in the event that hole radius or diameter and/or disc thickness change.

It should be appreciated that the particulars of the recording operation form no part of the invention.

Further, in accordance with at least one embodiment of the invention, the components of the apparatus provided for disc transportation may be combined with both a disc recorder and a disc printer that may be configured to cooperate under control of a machine instructions such that a plurality of discs may be transported to/from a disc recorder and to/from a disc printer, while ensuring that movement of one or more of the disc transportation apparatuses is performed in a single plane of operation. Thus, in an implementation where two disc transportation apparatuses are provided, each apparatus may move a transported disc in a single plane of movement. Moreover, in accordance with at least one implementation, both such apparatuses may perform motion in the same plane of operation. Alternatively, various configurations of movement may be provided, e.g., planes of movement that are orthogonal.

As a result, it will be apparent for those skilled in the art that the illustrative embodiments described are only examples and that various modifications can be made within the scope of the invention as defined in the appended claims.

1. An apparatus for transporting discs to equipment for recording data on said discs, the apparatus comprising:
a dual arm linkage assembly;
a gear assembly coupled to the dual arm linkage assembly and configured to provide translation of a rotational force to move the dual arm linkage assembly; and
a disc gripper arm coupled to the dual arm linkage assembly and configured to move in a single plane of movement so as to pick up, transport and deposit a single disc at a plurality of stations aligned along the single plane of movement.

2. The apparatus of claim 1 further comprising a motor coupled to the dual arm linkage assembly via the gear assembly.

3. The apparatus of claim 1, wherein the dual arm linkage assembly comprises a pulley arm and a slave arm coupled together via juncture plate coupled to the disc gripper arm.

4. The apparatus of claim 1, wherein the gear assembly comprises one or more pulleys configured to operationally interact via a timing belt so as to translate the rotational force to move the dual arm linkage assembly in the single plane of movement.

5. The apparatus of claim 1, further comprising a plurality of phototransistors positioned in proximity to the dual arm linkage assembly and configured to indicate operation or malfunction of the apparatus.

6. The apparatus of claim 1, wherein the disc gripper arm includes a disc gripper arm head assembly configured to engage and disengage with a disc.

7. The apparatus of claim 6, wherein the disc gripper arm head assembly includes a plurality of fingers, at least one of the fingers being configured to operationally interact with a solenoid so as to alter the relative distance between at least parts of the plurality of fingers so as to engage or disengage with a central hole of a disc.

8. The apparatus of claim 1, wherein the disc gripper arm includes a solenoid coupled to the disc gripper arm head assembly and configured to move at least one finger included in the disc gripper arm head assembly so as to enable engaging a central hole in a disc with at least the finger.

9. The apparatus of claim 8, wherein the at least one finger included in the disc gripper arm head assembly has a tapered end.

10. The apparatus of claim 1, further comprising a blank disc storage station and a recorded disc storage station.

11. The apparatus of claim 10, wherein the disc storage stations include disc cassettes configured to facilitate stacking of a plurality of discs.

12. The apparatus of claim 10, wherein the recorded disc storage station includes a cassette configured such that the cassette has a variable diameter that reduces to a minimum diameter capable of including a disc at a base of the cassette.

13. The apparatus of claim 1, coupled to a disc recorder wherein both the apparatus of claim 1 and the disc recorder are configured to cooperate to provide automated or semi-automated transportation, recordation and storage of a plurality of discs.

14. The apparatus of claim 13, further comprising a motor coupled to the gear assembly to provide movement force to the dual arm linkage assembly to move the gripper arm.

15. The apparatus of claim 14, further comprising a controller for controlling movement of the dual-linkage arm assembly by controlling operation of the motor.

16. A method of transporting discs to equipment for recording data on said discs, the method comprising:
engaging a central hole of a disc stored in a first storage station with a plurality of gripper arm fingers; and
moving the engaged disc to a disc recording station via a gripper arm; and
disengaging the plurality of gripper arm fingers from the central hole of the disc so as to drop the disc in a tray at the disc recording station,
wherein the gripper arm is moved in a single plane of movement between a first storage station, a disc recorder and a second storage station, wherein said single plane is aligned with an axis upon which the first storage station, disc recording station and second storage station are positioned and wherein the gripper arm is moved by and coupled to a dual arm linkage assembly so as to pick up, transport and deposit a single disc along a plurality of stations aligned along the single plane of movement.

17. The method of claim 16, further comprising:
engaging a central hole of the disc with a plurality of gripper arm fingers following processing of the disc at the disc recording station;
moving the engaged disc to a second storage station via the gripper arm; and
disengaging the plurality of gripper arm fingers from the central hole of the disc so as to drop the disc in the second storage station.

18. The method of claim 16, wherein the dual arm linkage assembly is moved via a gear assembly coupled to a motor, wherein, the dual arm linkage assembly comprises a pulley arm and a slave arm coupled together via juncture plate coupled to the gripper arm.

19. The method of claim 18, wherein the gear assembly comprises one or more pulleys configured to operationally interact via a timing belt so as to translate the rotational force to move the dual arm linkage assembly in the single plane of movement.

20. The method of claim 16, wherein engaging and disengaging a central hole of the disc includes moving at least one of the plurality of gripper arm fingers via a solenoid so as to alter the relative distance between at least parts of the plurality of fingers so as to engage or disengage with a central hole of a disc.
